(19) United States
(12) Patent Application Publication
(10) Pub. No.: US 2025/0067618 A1
(43) Pub. Date: Feb. 27, 2025

(54) DETECTING LEAKAGES IN UNDERGROUND PIPELINES

(71) Applicant: Leak Detector AS, SANDNES (NO)

(72) Inventor: Morten Talgø, SANDNES (NO)

(73) Assignee: Leak Detector AS, SANDNES (NO)

(21) Appl. No.: 18/721,421

(22) PCT Filed: Feb. 14, 2023
(86) PCT No.: PCT/NO2023/050035

§ 371 Date: Jun. 18, 2024

(30) Foreign Application Priority Data
Feb. 14, 2022 (NO) 20220204

(51) Int. Cl. G01M 3/24; G01H 9/00

(52) U.S. Cl. CPC G01M 3/243; G01H 9/004

(57) ABSTRACT

A method and a system are for detecting at least one leak or at least one leak property in an underground pipeline, the underground pipeline being arranged near an underground conduit which is either a sewage conduit or a surface water conduit. The method has the steps of: providing at least one optical sensing fiber that extends inside and along underground conduit; obtaining distributed acoustic sensing data from the optical sensing fiber; and using the obtained distributed acoustic sensing data to detect the leak the at least one leak property in the underground pipeline.

### CROSS-REFERENCE TO RELATED APPLICATIONS

This application is the U.S. national stage application of International Application No. PCT/NO2023/050035, filed Feb. 14, 2023, which international application was published on Aug. 17, 2023, as WO 2023/153939 in the English language. The International Application claims priority to Norwegian patent application No. 20220204, filed Feb. 14, 2022. The international application and Norwegian application are both incorporated herein by reference, in their entirety.

### FIELD

The present invention relates to the detection of leakages and properties associated with leaks in underground pipelines, and in particular, it relates to a method for detecting at least one leak in an underground pipeline, a method for detecting one or more properties associated with at least one leak in an underground pipeline, apparatus for detecting a leak or a leak property in such a pipeline, a system including the apparatus, and a flexible elongate member.

### BACKGROUND

For any underground pipeline, for example underground water pipelines, the likelihood for leakages to develop typically increases with time. There are economic and environmental incentives to find leakages and repair them.

Several methods exist for detecting leakages in an underground water pipeline. One method is to measure the flow in the pipeline with a flowmeter at different locations along the pipeline. By comparing the flow at the different locations, an estimated location for a leakage can be found. However, this method requires a disruptive installation process, where the pipeline flow must typically be stopped temporarily. It also has low positional accuracy when determining the location of the leakage.

Another method is to use a noise logger or an accelerometer to monitor noise. This method can detect leakages in the vicinity of the measuring point but cannot detect the location of the leak with high precision. Correlating noise measurements at multiple measuring points along the water pipeline can reveal an estimated leakage location. The noise monitor method has several drawbacks. Firstly, it has poor signal-to noise ratio and a poor positional accuracy. Secondly, the process require access to multiple valve chambers. Furthermore, the noise logger or the accelerometer detects vibrations in the water pipeline walls. This method is therefore sensitive to the material of the water pipeline, because vibrations caused by a leakage propagate longer in metal pipes than in pipes made of a plastic material.

A yet further method involves using a hydrophone may for detecting leakages in a pipeline. It has an improved signal strength compared to a noise logger. However, the process using a hydrophone is a disruptive process and requires access to multiple valve chambers.

Furthermore, leakages in a water pipeline may also be detected by manually searching on the surface of the ground using microphones. This is a method with poor signal-to-noise ratio and often requires personnel to engage in the searching during night-time working hours when the ambient noise levels are lower.

In view of the above-described problems there is a need to develop a method for detecting leakages in a water pipeline.

### SUMMARY

At least one aim of the present invention is to obviate or at least mitigate one or more drawbacks of the prior art.

According to a first aspect of the invention, there is provided a method of detecting at least one leak in an underground pipeline. The underground pipeline is arranged near an underground conduit which is either a sewage conduit or a surface water conduit. The method comprises the steps of: providing at least one optical sensing fibre that extends inside and along the underground conduit; obtaining distributed acoustic sensing data from the optical sensing fibre; and using the obtained distributed acoustic sensing data to detect the leak in the underground pipeline.

The method of the first aspect of the invention can facilitate to detect a leak in an underground pipeline that may be difficult to monitor otherwise. The method of the first aspect can be a method of detecting at least one leak and detecting one or more leak properties associated with the at least one leak in the underground pipeline, and in such variants, the method of the first aspect may further include using the obtained distributed acoustic sensing data to detect the one or more leak properties.

According to a second aspect of the invention, there is provided a method of detecting one or more leak properties associated with at least one leak in an underground pipeline. The underground pipeline is arranged near an underground conduit which is either a sewage conduit or a surface water conduit. The method comprises the steps of: providing at least one optical sensing fibre that extends inside and along the underground conduit; obtaining distributed acoustic sensing data from the optical sensing fibre; and using the obtained distributed acoustic sensing data to determine one or more leak properties associated with the at least one leak in the underground pipeline.

The method of the second aspect of the invention, can be used to detect the position of the leak in the underground pipeline, and do so with precision. The method of the second aspect can be a method of detecting at least one leak and detecting one or more leak properties associated with the at least one leak in the underground pipeline, and in such variants, the method of the second aspect may further include using the obtained distributed acoustic sensing data to detect the at least one leak.

The method of the second aspect may further comprise using the strength of the acoustic field and the known distance between the underground pipeline and the underground conduit, to esti-mate the size and/or severity of the leak in the underground pipeline.

In either of the above aspects of the invention, the sewage conduit may be or may comprise a sewage pipeline or channel. The surface water conduit may be or may comprise a surface water drainage pipeline or channel. Sewage may be communicated along the sewage conduit within a sewage system. Storm water or other surface water may be communicated along the surface water conduit within a storm water/surface water drain system. The underground conduit may have any cross-sectional shape, e.g. round, square, oval, etc.

The underground pipeline may for example be a pressurized, underground pipeline such as a water pipeline. By installing the optical sensing fibre in the underground conduit, it is possible to do distributed acoustic sensing measurements remote from the underground pipeline, so that leaks can be detected in the underground pipeline non-invasively. Thus, fluid flow in the underground pipeline can continue. In examples where the underground pipeline is a water pipeline, water flow in the water pipeline can continue, and water pressure in the pipeline maintained, while measurements take place from the conduit. In examples where the water in the water pipeline is drinking water, maintaining water pressure hinders contamination of the drinking water from the surrounding environments by bacteria, viruses, or toxic materials. A manhole can be conveniently used to access the pipeline for installing the optical sensing fibre in the underground conduit.

Furthermore, the method can be conveniently employed in examples where the underground pipeline comprises an iron pipeline for example carrying drinking water. By using the optical distributed acoustic sensing fibre in the conduit to detect the leak or property of the leak in the underground pipeline, the leak can be detected remotely and assessed without invasion of the underground pipeline, which can be valuable if the iron pipeline has developed rust which is not supposed to be disturbed for risk of being dislodged into the drinking water to end-users.

The method may be effective if the underground pipeline is pressurized. Examples of pressurized, underground pipelines are water pipelines for drinking water distribution, pipelines for district heating, central heating or gas distribution.

The method may also be advantageous for monitoring non-pressurized, underground pipelines that are for example hard to reach or should preferably not be interfered with.

The underground pipelines may be made of a plastics or a cement material.

In various embodiments, the underground pipeline is arranged parallel to the underground conduit, along at least part of the length of the underground pipeline. In such embodiments the length of the optical sensing fibre may extend along the underground pipeline. This may facilitate detecting the leak and/or detecting the leak position along the pipeline, e.g. the leak position may be obtained with greater precision.

The method of the first or second aspect of the invention may further comprise providing an optical unit which may be coupled to the at least one optical sensing fibre and wherein the step of obtaining the distributed acoustic sensing data from the at least one optical sensing fibre may comprise using the optical unit, transmitting light into the at least one optical sensing fibre and receiving light from the at least one optical sensing fibre.

In certain embodiments, the method of the first or second aspect of the invention may further comprise providing a flexible elongate member which may extend inside and along the underground conduit, the flexible elongate member comprising the optical sensing fibre. In embodiments where the flexible elongate member is provided, the flexible elongate member may comprise a length of rope or braided cable. The flexible elongate member may comprise at least one layer of or comprising load bearing fibres. The load bearing fibres may surround a core of the flexible elongate member. The load bearing fibres may comprise polyethylene fibres, aramid fibres or other fibres of other materials. The load bearing fibres may comprise Dyneema® polyethylene fibres. The flexible elongate member may be wound on a drum, which may facilitate deployment and retrieval of the flexible elongate member into and from the underground conduit.

In embodiments where the flexible elongate member is provided, the flexible elongate member, along at least part of its length, may be at least partially submerged in or floating upon fluid contents of the underground conduit.

In embodiments where the flexible elongate member is provided and deployed in an underground conduit, the flexible elongate member can be aligned to extend along the underground conduit by a current of the fluid in the underground conduit to facilitate obtaining the distributed acoustic sensing data. Further, the flexible elongate member may be free to be movable laterally from side to side, in particular toward a distal end, when in use in the underground conduit. The flexible elongate member may typically also be free to be movable upwardly in the fluid content within the underground conduit or be positionable in the fluid spaced away from the bottom of the underground conduit, when in use therein. Accordingly, the flexible elongate member can conveniently obtain a configuration in the underground conduit that may be suitable for performing measurements. Furthermore, the flexible elongate member may be responsive to the fluid current and be self-supported upon the fluid. This may reduce or avoid having objects stuck to the member, avoid blockage and/or further facilitate measurement data quality. The installation of the flexible elongate member in the underground conduit and its subsequent retrieval can be car-ried out quickly and efficiently. For example, deployment or retrieval may be possible simply by feeding the flexible elongate member into or out of the underground conduit, and typically without personnel requiring personal protective equipment, or without personnel coming into contact with the contents of the underground conduit such as solids, liquids and toxic gasses. The flexible elongate member can be provided and installed without imparting strain to or otherwise affecting or interfering with the structure of the underground conduit.

The method according to the first or second aspect of the invention, in embodiments where the flexible elongate member is provided, may further comprise letting the flexible elongate member obtain an operational configuration in the fluid content in which the flexible elongate member may extend along the underground conduit and be spaced apart from the bottom of the underground conduit. It can be advantageous that the flexible elongate member may be spaced apart from the bottom of the underground conduit as this may reduce the risk or avoid objects getting stuck on the member, avoid blockage and/or further facilitate measurement data quality.

In various embodiments, the method of the first or second aspect of the invention, may further comprise providing a cable which extends inside and along the underground conduit, the cable comprising the at least one optical sensing fibre. The method may comprise further the step of installing the cable at an inside wall of the underground conduit. The cable may be fastened to the inside wall of the underground conduit. The cable may be fastened to the inside wall using clamps or other fastening means. The inside wall may typically be the bottom of the underground conduit. It can be advantageous to install the cable comprising the optical sensing fibre at the inside wall of the underground conduit, to have control of the exact position of the cable along the underground conduit.

In an embodiment, the method of the first or second aspect, may further comprise the steps of: obtaining fibre optic sensing measurement data from the at least one optical sensing fibre along the underground conduit; and using the obtained fibre optic sensing measurement data to determine one or more properties associated with the underground conduit.

It can be advantageous to use the same installation to obtain fibre optic sensing measurement data to determine the one or more properties associated with the underground conduit, and to obtain distributed acoustic sensing data to detect a leak or determine one or more leak properties associated with a leak in the underground pipeline. Using the same installation can save time and the obtained data may be correlated. It can be useful to measure for example the distributed temperature using the fibre optic sensing measurement data as it can help to separate out sources of noise in the underground conduit.

The same optical sensing fibre can be used to obtain the fibre optic sensing measurement data and to obtain the distributed acoustic sensing data, using a switch. By switching often between the mode of measurements, that is fibre optic sensing and distributed acoustic sensing, the measurements can be made approximately at the same time. Two separate optical sensing fibres may alternatively be used, one to obtain the fibre optic sensing measurement data inside the underground conduit and one to obtain the acoustic sensing data from the underground pipeline. More than two optical sensing fibres may be used to obtain fibre optic sensing measurement data. The optical sensing fibres may be disposed within the same flexible elongate member, or within the same cable. The advantage of performing the different measurements in separate optical sensing fibres is that the measurements may be performed at the same time.

The fibre optic sensing measurements performed may be distributed acoustic sensing, distributed temperature sensing, distributed pressure sensing or fibre bragg grating sensing. The optical sensing fibre may have gratings to allow discrete detection of parameters associated with the underground conduit.

The method of the first aspect of the invention can have any one or more further features as set out above in relation to the method of the second aspect of the invention, and vice versa, the method of the second aspect of the invention can have any one or more further features as set out above in relation to the method of the first aspect of the invention.

According to a third aspect the invention, there is provided apparatus for detecting a leak or at least one leak property in an underground pipeline located in an underground region. The underground region includes an underground conduit which is either a sewage conduit or a surface water conduit located in proximity to the underground pipeline. The apparatus comprises: at least one optical sensing fibre configured to be located inside and along the underground conduit; at least one unit for obtaining distributed acoustic sensing data from the at least one optical sensing fibre; data processing means operable to detect the leak or the at least one leak property based upon the obtained distributed sensing data.

The apparatus of the third aspect may have one or more further features corresponding to those set out in the steps or otherwise as set out above in relation to the method of the first or second aspect of the invention.

According to a fourth aspect of the invention, there is provided a system comprising: an underground pipeline; an underground conduit in proximity to the underground pipeline; and the apparatus according to the third aspect of the invention, wherein the at least one optical sensing fibre is located along at least part of its length inside and along the underground conduit.

According to a fifth aspect of the invention, there is provided a flexible elongate member comprising at least one optical sensing fibre and being configured to be at least partially submerged or float in a fluid content inside an underground conduit, which is either a sewage conduit or a surface water conduit, for obtaining distributed acoustic sensing measurements along an underground pipeline that is adjacent to the underground conduit.

### BRIEF DESCRIPTION OF THE DRAWINGS

There will now be described, by way of example only, embodiments of the invention with reference to the accompanying drawings, in which:

FIG. 1 is a schematic representation of an underground region with an optical sensing fibre located in a sewage pipeline for detecting a leak in a water distribution pipeline;

FIG. 2 is a schematic representation of an underground region with an optical sensing fibre located in a surface water drainage pipeline for detecting a leak in a water distribution pipeline; and

FIG. 3 is a schematic representation of apparatus including a flexible elongate member which is deployed into an underground conduit for detecting a leak in an underground pipeline located near the conduit.

### DETAILED DESCRIPTION OF THE DRAWINGS

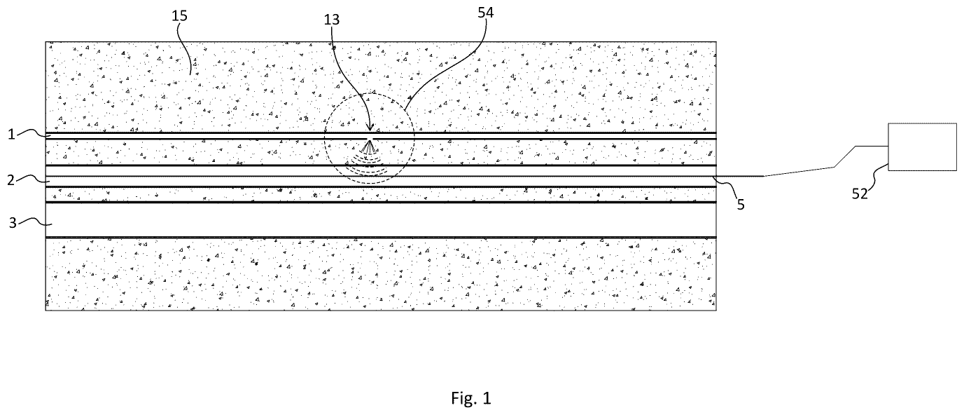

FIG. 1 shows a pipeline 1 positioned under the ground 15. The underground pipeline 1 is in this example a water pipeline 1 for water distribution. An underground conduit, in FIG. 1 shown as a sewage pipeline 2, runs adjacent to the water pipeline 1. In FIG. 1 an optical sensing fibre 5 is provided within and extends along the sewage pipeline 2.

The optical sensing fibre 5 extends along the sewage pipeline 2 so that the length of the optical sensing fibre 5 corresponds to the same length in the water pipeline 1.

One end of the optical sensing fibre 5 is connected to an optical unit 52. The optical unit 52 is configured for transmitting light into the optical sensing fibre 5 and receiving light from the optical sensing fibre 5. A light source within the optical unit 52 is arranged to transmit light signals through the optical sensing fibre 5.

If there is a leakage 13 in the water pipeline 1, an acoustic field 54 is formed around the leakage point. When pulses of light are transmitted by the optical unit 52 through the optical sensing fibre 5, located in the adjacent sewage pipeline 2, acoustic waves which propagate and are incident upon the optical sensing fibre 5 from the acoustic field 54, will affect the reflected signal received by the optical unit 52. Effects in the incoming reflected signals affected by the acoustic field can then be used to locate the acoustic field 54 and/or the leakage 13 that caused it.

The acoustic field 54 is detected at a location along the optical sensing fibre 5. Since the optical sensing fibre 5 extends along the sewage pipeline 2 that is adjacent to the water pipeline 1, the location of the detected acoustic field 54 along the optical sensing fibre 5 corresponds to the same location in the water pipeline 1. It is therefore possible to find leakages in the water pipeline 1 with a high positional accuracy.

Distributed acoustic sensing can detect the acoustic field 54 created by the leakage 13 directly and does not require or rely upon vibrations propagating in the walls of the water pipeline 1. The technique described above can therefore be effective in water pipelines of various constructions. In some variants for example, the water pipeline 1 is made of a plastics or a cement material. In other variants, the water pipeline 1 is made of metal.

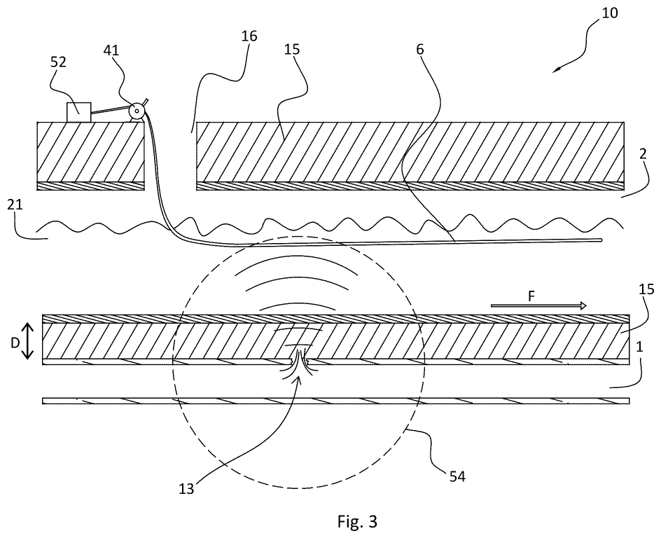

FIG. 3 shows apparatus 10 for detecting a leak 13 in a water pipeline 1, located under the ground 15. The water pipeline 1 runs adjacent to a sewage pipeline 2, with a distance D between them.

The apparatus 10 includes a flexible elongate member in the form of a rope 6 comprising an optical sensing fibre inside the rope (not visible in FIG. 3). The flexible elongate member in other examples is a cable of polyethylene fibres or a cable or rope of other lightweight material or fibres. The density of the materials of the rope 6 is configured such that the rope can float or is at least partially submerged in a fluid, in use. The rope 6 is connected to an optical unit 52 located above the ground 15.

The apparatus 10 is shown during deployment into a section of a sewage pipeline 2. The rope 6 is located inside the sewage pipeline 2, submerged in the fluid 21 inside the sewage pipeline 2. A deployment means including a drum 41 has spooled out the rope 6 through a manhole 16 into the sewage pipeline 2 and the apparatus 10 is ready for performing distributed acoustic sensing measurements with the rope 6 having obtained an operational configuration. The fluid 21 is flowing in a direction F. The flow imparts a force on the rope 6, against the retainment from a brake on the drum 41 to tension and/or align the rope 6 along the sewage pipeline 2. The rope 6 is therefore straightened out and extends along the sewage pipeline 2. A length of the rope corresponds therefore to the same length in the water pipeline 1.

In FIG. 3 only a short length of the rope 6 is shown immersed in the fluid 21, but it will be ap-preciated that in operational use, the rope 6 inside the sewage pipeline 2 can be of any suitable length and typically longer.

In practice, the distance D between the water pipeline 1 to be monitored and the sewage pipeline 2 that contains the optical sensing fibre 5 would be small enough for the optical sensing fibre 5 to detect an acoustic field 54 created by a leak 13. How far away the optical sensing fibre 5 can be from the source of the acoustic field 54 and still detect the leak can of course vary and may de-pend upon amongst other things, the strength of the acoustic field 54, the subsurface media, and the surrounding noise which may affect the signal-to-noise ratio. Typically, the distance D is in the range of up to two metres, but data may be acquired allowing the leak to be detected or leak properties to be determined in situations when the distance D is two metres or more.

In FIGS. 1 and 3, by using the optical sensing fibre 5 in the sewage pipeline 2, a leakage 13 can be detected in a different nearby underground pipeline, namely the water pipeline 1 for water transportation. However, this method is equally applicable using the optical sensing fibre 5 in the sewage pipeline 2 for detecting leakages in other types of underground pipelines for examples pipelines for district heating, central heating, or gas distribution, instead of or in addition to the water pipeline 1.

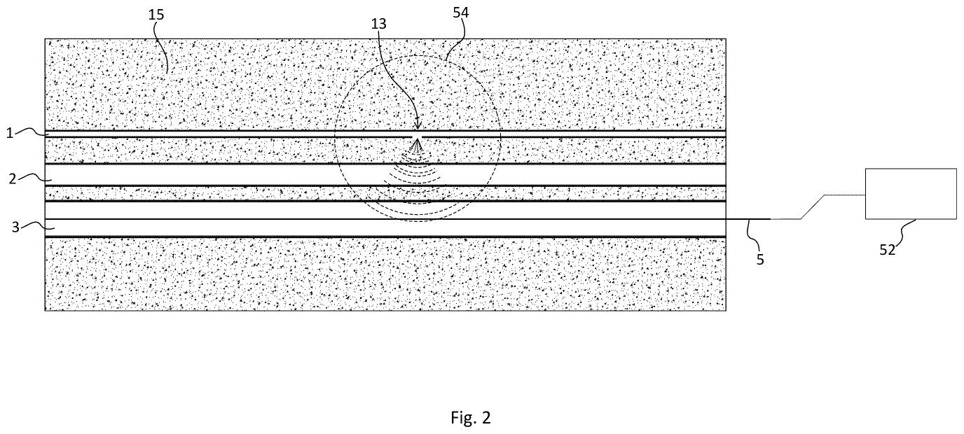

Instead of providing the optical sensing fibre 5 within a sewage pipeline 2 as shown in FIGS. 1 and 3 the optical sensing fibre 5 can be provided within and extend along a surface water drainage pipeline 3 as shown in FIG. 2. The surface water drainage pipeline 3 runs adjacent to the water pipeline 1. Although in FIG. 2 a sewage pipeline 2 is also present, in other variants where the optical sensing fibre is deployed in a surface water drainage pipeline 3, the sewage pipe 2 is not present. In further variants, an optical sensing fibre is located in the surface water drainage pipeline 3 and another optical sensing fibre is located in the sewage pipeline 2.

In various other variants of the examples described, several optical sensing fibres may be disposed within either or both of surface water drainage pipeline 3 or the sewage pipeline 2. For example in one variant, one optical sensing fibre is used both for optical sensing data measurements of one or more properties of the pipeline 2, 3 in which it is located, and for detecting the leak in the water pipeline 1. Alternatively, one optical sensing fibre is used to obtain optical sensing data measurements of one or more properties the pipeline 2, 3 in which it is located, and another optical sensing fibre being used to detect the leak in the water pipeline 1. Instead of the surface water drainage pipeline 3 and the sewage pipeline 2 being pipelines, alternatively they are a surface water drainage channel and a sewage channel.

1. A method of detecting at least one leak in an underground pipeline, the underground pipeline being arranged near an underground conduit which is either a sewage conduit or a surface water conduit, the method comprising the steps of:
providing at least one optical sensing fiber that extends inside and along the underground conduit;
obtaining distributed acoustic sensing data from the at least one optical sensing fiber; and
using the obtained distributed acoustic sensing data to detect the leak in the underground pipeline.

2. A method of detecting one or more leak properties associated with at least one leak in an underground pipeline, the underground pipeline being arranged near an underground conduit which is either a sewage conduit or a surface water conduit, the method comprising the steps of:
providing at least one optical sensing fiber that extends inside and along the underground conduit;
obtaining distributed acoustic sensing data from the at least one optical sensing fiber; and
using the obtained distributed acoustic sensing data to determine one or more leak properties associated with the at least one leak in the underground pipeline.

3. The method according to claim 1, wherein the underground pipeline is arranged parallel to the underground conduit.

4. The method according to claim 1, which further comprises providing an optical unit which is coupled to the at least one optical sensing fiber and wherein the step of obtaining the distributed acoustic sensing data from the at least one optical sensing fiber comprises using the optical unit, transmitting light into the at least one optical sensing fiber and receiving light from the at least one optical sensing fiber.

5. The method according to claim 1, which further comprises providing a flexible elongate member which extends inside and along the underground conduit, the flexible elongate member comprising the at least one optical sensing fiber.

6. The method according to claim 5, wherein the flexible elongate member along at least part of its length is at least partially submerged in or floating upon fluid contents of the underground conduit.

7. The method according to claim 6, further comprising letting the flexible elongate member obtain an operational configuration in the fluid contents in which the flexible elongate member extends along the underground conduit and is spaced apart from a bottom of the underground conduit.

8. The method according to claim 1, which further comprises providing a cable which extends inside and along the underground conduit, the cable comprising the at least one optical sensing fiber, and the method further comprising the steps of:
installing the cable at an inside wall of the underground conduit.

9. The method according to claim 8, further comprising:
fastening the cable to the inside wall of the underground conduit with clamps.

10. The method according to claim 1, which further comprises:
obtaining fiber optic sensing measurement data from the at least one optical sensing fiber along the underground conduit; and
using the obtained fiber optic sensing measurement data to determine one or more properties associated with the underground conduit.

11. An apparatus for detecting a leak or at least one leak property in an underground pipeline located in an underground region, the underground region including an underground conduit which is either a sewage conduit or a surface water conduit located in proximity to the underground pipeline, the apparatus comprising:
at least one optical sensing fiber configured to be located inside and along the underground conduit;
at least one unit for obtaining distributed acoustic sensing data from the at least one optical sensing fiber;
data processing means operable to detect the leak or the at least one leak property based upon the obtained distributed sensing data.

12. A system comprising:
an underground pipeline;
an underground conduit which is either a sewage conduit or a surface water conduit in proximity to the underground pipeline; and
the apparatus as claimed in claim 11, the at least one optical sensing fiber being located along at least part of its length inside and along the underground conduit.

13. A flexible elongate member comprising at least one optical sensing fiber and being configured to be at least partially submerged or float in a fluid content inside an underground conduit which is either a sewage conduit or a surface water conduit for obtaining distributed acoustic sensing measurements along underground pipeline that is adjacent to the underground conduit.

14. The method according to claim 2, wherein the underground pipeline is arranged parallel to the underground conduit.

15. The method according to claim 2, which further comprises providing an optical unit which is coupled to the at least one optical sensing fiber and wherein the step of obtaining the distributed acoustic sensing data from the at least one optical sensing fiber comprises using the optical unit, transmitting light into the at least one optical sensing fiber and receiving light from the at least one optical sensing fiber.

16. The method according to claim 3, which further comprises providing an optical unit which is coupled to the at least one optical sensing fiber and wherein the step of obtaining the distributed acoustic sensing data from the at least one optical sensing fiber comprises using the optical unit, transmitting light into the at least one optical sensing fiber and receiving light from the at least one optical sensing fiber.

17. The method according to claim 2, which further comprises providing a flexible elongate member which extends inside and along the underground conduit, the flexible elongate member comprising the at least one optical sensing fiber.

18. The method according to claim 3, which further comprises providing a flexible elongate member which extends inside and along the underground conduit, the flexible elongate member comprising the at least one optical sensing fiber.

19. The method according to claim 4, which further comprises providing a flexible elongate member which extends inside and along the underground conduit, the flexible elongate member comprising the at least one optical sensing fiber.

20. The method according to claim 2, which further comprises providing a cable which extends inside and along the underground conduit, the cable comprising the at least one optical sensing fiber, and the method further comprising the steps of:
installing the cable at an inside wall of the underground conduit.
